(19) United States
(12) Patent Application Publication
(10) Pub. No.: US 2024/0087796 A1
(43) Pub. Date: Mar. 14, 2024

(54) Small Volume Transformer Structure

(71) Applicant: AA Power Inc., Boston, MA (US)

(72) Inventor: Qun Lu, Lexington, MA (US)

(21) Appl. No.: 18/242,503

(22) Filed: Sep. 5, 2023

Related U.S. Application Data
(60) Provisional application No. 63/375,550, filed on Sep. 14, 2022.

(51) Int. Cl. H01F 27/28; H01F 27/24; H01F 27/29; H01F 27/32

(52) U.S. Cl. CPC H01F 27/2852; H01F 27/24; H01F 27/292; H01F 27/323

(57) ABSTRACT

A transformer winding includes a first metal sheet of a first sheet type and a second metal sheet of a second sheet type stacked with one on top of the other, and an insulating film disposed between the first and second metal sheets. Each sheet type includes a body in a ring shape with an opening on a lower portion of the ring shape, and a first terminal and a second terminal extending respectively downward from two ends of the opening. The first and second sheet types have same distance between the first and second terminals, and different distances from the first terminals to a centerline of the ring shape. The transformer winding may be made different by changing the distances from the first terminals to the centerline. A transformer including the transformer winding as the secondary winding is also provided.

### CROSS-REFERENCE TO RELATED APPLICATIONS

This patent application claims priority to U.S. Provisional Application No. 63/375,550, filed on Sep. 14, 2022 and entitled “Small Volume Transformer Structure,” which is hereby incorporated by reference herein as if reproduced in its entirety.

### TECHNICAL FIELD

The present disclosure relates to the field of transformers, and in particular embodiments, to a small volume transformer structure.

### BACKGROUND

A power conversion system usually includes an AC/DC stage and a DC/DC stage connected in cascade between an AC utility line and a plurality of loads. The AC/DC stage converts the power from the AC utility line to an intermediate DC distribution bus. The DC/DC stage converts the voltage on the intermediate DC distribution bus to a plurality of voltage levels for the plurality of loads. A conventional AC/DC stage may include a variety of electromagnetic interference (EMI) filters, a bridge rectifier formed by four diodes, a power factor correction circuit and an isolated DC/DC power converter. The DC/DC stage may include a plurality of isolated DC/DC converters. Isolated DC/DC converters may be implemented by using different power topologies, such as LLC resonant converters, flyback converters, forward converters, half bridge converters, full bridge converters and the like.

In the power conversion system, a transformer is employed to provide isolation between a primary side and a secondary side of an isolated power converter. In order to increase the power delivered from the primary side to the secondary side, a plurality of transformers may be employed. The plurality of transformers may be integrated into a single device known as an integrated magnetics structure. An example integrated magnetics structure may include a pair of magnetic cores, a plurality of primary windings and a plurality of secondary windings. The use of the integrated magnetics structure improves performance with a reduction in size and weight.

With the advancement of electronic technologies, it is desirable to develop power supply products having higher power density, higher efficiency, and smaller sizes. Transformers, as one of core components of power supplies, are facing challenges to reduce sizes, improve power density and ensure layout matching performance.

### SUMMARY

These and other problems are generally solved or circumvented, and technical advantages are generally achieved, by embodiments of the present disclosure which provide a small volume transformer structure.

According to one aspect of the present disclosure, a transformer is provided that includes a structure. The structure includes a core comprising a first leg, a second leg, and a third leg disposed between the first leg and the second leg. The structure further includes a first secondary winding disposed around the first leg, the first secondary winding comprising a first copper sheet of a first sheet type and a second copper sheet of a second sheet type, the first copper sheet and the second copper sheet being stacked with a rear surface of the first copper sheet disposed on top of a front surface of the second copper sheet, the first sheet type comprising a first body in a ring shape with a first opening, and a first terminal and a second terminal extending respectively from two ends of the first opening along a centerline of the ring shape, and the second sheet type comprising a second body in the ring shape with a second opening, and a first terminal and a second terminal extending respectively from two ends of the second opening along the centerline. The structure further includes a second secondary winding disposed around the second leg, the second secondary winding comprising a third copper sheet of the first sheet type and a fourth copper sheet of the second sheet type, the third copper sheet and the fourth copper sheet being stacked with a front surface of the third copper sheet disposed on top of a rear surface of the fourth copper sheet. The structure also includes a third secondary winding disposed around the third leg, the third secondary winding comprising a fifth copper sheet and a sixth copper sheet of a third sheet type, the fifth copper sheet and the sixth copper sheet being stacked with a rear surface of the fifth copper sheet disposed on top of a rear surface of the sixth copper sheet, the third sheet type comprising a third body in the ring shape with a third opening, and a first terminal and a second terminal extending respectively from two ends of the third opening along the centerline. Respective distances between first terminals and second terminals of the first, second and third sheet types are same. Respective distances from the first terminals or the second terminals of the first, second and third sheet types to the centerline of the ring shape are different from one another. The centerlines of the first to sixth copper sheets are perpendicular to the longitudinal direction of the core.

According to another aspect of the present disclosure, a transformer winding is provided that includes a first metal sheet of a first sheet type, the first sheet type comprising a first body in a ring shape with a first opening on a lower portion of the ring shape, and a first terminal and a second terminal extending respectively downward from two ends of the first opening; a second metal sheet of a second sheet type, the second sheet type comprising a second body in the ring shape with a second opening on the lower portion of the ring shape, and a first terminal and a second terminal extending respectively downward from two ends of the second opening, the second opening being different from the first opening. A distance between the first terminal and the second terminal of the second sheet type is same as a distance between the first terminal and the second terminal of the first sheet type. First terminals and second terminals of the first metal sheet and the second metal sheet have a same width, and the first metal sheet and the second metal sheet are stacked with one on top of the other along a centerline of the ring shape. The transformer winding also includes an insulating film disposed between the first metal sheet and the second metal sheet.

According to another aspect of the present disclosure, an apparatus is provided that includes a transformer. The transformer includes a core comprising a first leg, a second leg, and a third leg disposed between the first leg and the second leg. The transformer further includes a first secondary winding disposed around the first leg, the first secondary winding comprising a first copper sheet of a first sheet type and a second copper sheet of a second sheet type, the first copper sheet and the second copper sheet being stacked with a rear surface of the first copper sheet disposed on top of a front surface of the second copper sheet, the first sheet type comprising a first body in a ring shape with a first opening, and a first terminal and a second terminal extending respectively from two ends of the first opening along a centerline of the ring shape, and the second sheet type comprising a second body in the ring shape with a second opening, and a first terminal and a second terminal extending respectively from two ends of the second opening along the centerline. The transformer further includes a second secondary winding disposed around the second leg, the second secondary winding comprising a third copper sheet of the first sheet type and a fourth copper sheet of the second sheet type, the third copper sheet and the fourth copper sheet being stacked with a front surface of the third copper sheet disposed on top of a rear surface of the fourth copper sheet. The transformer also includes a third secondary winding disposed around the third leg, the third secondary winding comprising a fifth copper sheet and a sixth copper sheet of a third sheet type, the fifth copper sheet and the sixth copper sheet being stacked with a rear surface of the fifth copper sheet disposed on top of a rear surface of the sixth copper sheet, the third sheet type comprising a third body in the ring shape with a third opening, and a first terminal and a second terminal extending respectively from two ends of the third opening along the centerline. Respective distances between first terminals and second terminals of the first, second and third sheet types are same. Respective distances from the first terminals or the second terminals of the first, second and third sheet types to the centerline of the ring shape are different from one another. The centerlines of the first to sixth copper sheets is perpendicular to the longitudinal direction of the core.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates an example conventional magnetic core in a perspective view, a top view, and a front view;

FIG. 2 illustrates three windings on the magnetic core in FIG. 1;

FIG. 3 illustrates example metal sheets of three different sheet types in accordance with various embodiments of the present disclosure;

FIG. 4 illustrates an example transformer structure in accordance with various embodiments of the present disclosure;

FIG. 5 illustrates another example transformer structure, highlighting connection of windings through a PCB, in accordance with various embodiments of the present disclosure;

FIG. 6 illustrates another example of metal sheets of three sheet types in accordance with various embodiments of the present disclosure;

FIG. 7 illustrates another example transformer structure utilizing the metal sheets illustrated in FIG. 6 in accordance with various embodiments of the present disclosure;

FIG. 8 illustrates the example transformer structure of FIG. 7, highlighting insulating films, in accordance with various embodiments of the present disclosure;

FIG. 9 illustrates two different insulating films in accordance with various embodiments of the present disclosure;

FIG. 10 illustrates an example epoxy board in a perspective view, a front view, a top view, and a side view, in accordance with various embodiments of the present disclosure;

FIG. 11 illustrates an example primary winding in accordance with various embodiments of the present disclosure;

FIG. 12 illustrates another example primary winding in accordance with various embodiments of the present disclosure;

FIGS. 13A-13F illustrate an example transformer in accordance with various embodiments of the present disclosure;

FIGS. 14A-14F illustrate another example transformer in accordance with various embodiments of the present disclosure; and

FIG. 15 illustrates an example circuit that may be used in a power supply circuit.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

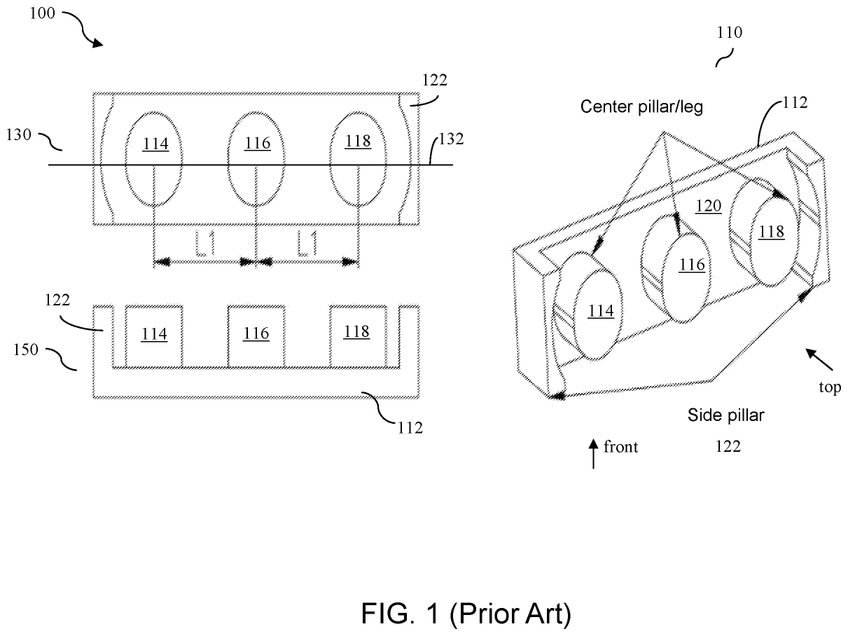

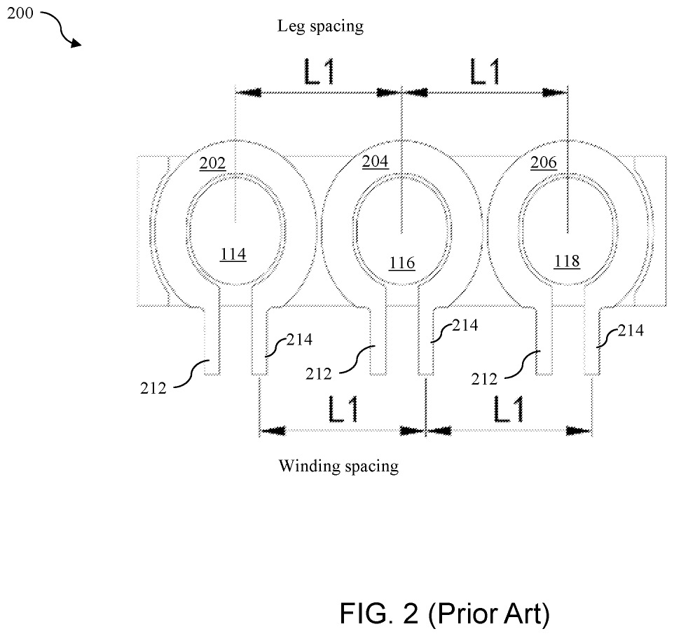

Transformer are widely used in various electronic devices and systems. As an example, in a power conversion system, a transformer is employed to provide isolation between a primary side and a secondary side of an isolated power converter. In order to increase the power delivered from the primary side to the secondary side, a plurality of transformers may be integrated into a single device having an integrated magnetics structure according to a conventional technology. For example, a transformer having the integrated magnetics structure may include a pair of magnetic cores, a plurality of primary windings, and a plurality of secondary windings. FIGS. 1 and 2 show an example integrated magnetics structure.

FIG. 1 is a diagram illustrating an example magnetic core 100 of the integrated magnetics structure, including a perspective view 110, a top view 130, and a front view 150 of the magnetic core 100. The magnetic core 100 includes a main body 112, and three core center pillars (also referred to legs) 114, 116 and 118 extending from the main body 112. As an example, the three legs 114, 116 and 118 extend from a surface 120 of the main body 112, in a direction perpendicular to the surface 120. The cross sections of the three legs 114, 116 and 118 may be in a shape of a circle, an oval, or other applicable shapes. This example shows a general oval shape, but a circle also applies, where the three legs 114, 116 and 118 may have a shape of cylinder. The centers of the three legs 114, 116 and 118 may be aligned along a horizontal line 132 in a left-right direction of the magnetic core 100. The horizontal line 132 may be a center line of the magnetic core in the left-right direction or longitudinal direction of the core 100. The three legs 114, 116 and 118 may be evenly spaced at a distance L1 (also referred to as leg spacing or pillar spacing in the following). The main body 112 may be in a U shape, and include two side pillars 122 encompassing the three legs 114, 116 and 118 in between.

The terms “top”, “bottom”, “lower”, “upper”, “front”, “rear”, “right”, “left”, “horizontal” and “vertical” as used herein are merely for illustration purposes to indicate relative positions or directions of components/elements of embodiments of the present disclosure, and are not intended to be limiting to the scope of the present disclosure. The relative positions or directions of the components/elements may be indicated or illustrated differently, and the terms may be interpreted differently and applied to the components/elements differently, which still falls within the scope of the present disclosure.

The three legs 114, 116 and 118 may be used to realize the windings of the transformer. In one embodiment, each leg may be used to realize the winding of one phase of the transformer, and thus, the transformer may have three phases. For example, the leg 114 may form a first phase transformer, the leg 116 may form a second phase transformer, and the leg 118 may for a third phase transformer. Compared with a power conversion system having three separate transformers, the magnetic core 100 with the structure as shown reduces the size of a transformer having three phases, thereby reducing the length of the magnetic circuit, lowering the magnetic loss and improving the efficiency of the transformer.

However, a drawback of the magnetic core 100 is that it has a fixed distance L1 between the legs as the legs are integrated in one core, which limits the distances between the windings placed on the legs.

FIG. 2 is a schematic diagram showing a top view 200 of three windings 202, 204 and 206 disposed on the magnetic core 100 as described in FIG. 1. The windings may be symmetrical copper windings. Each winding has a first terminal 212 and a second terminal 214. A distance between the first (or second) terminals of two adjacent windings may be referred to as a spacing of the windings (or referred to as a winding spacing), e.g., the distance between the terminal 212 of the winding 202 and the terminal 212 of the winding 204, the distance between the terminal 214 of the winding 202 and the terminal 214 of the winding 204, or the distance between the terminal 214 of the winding 204 and the terminal 214 of the winding 206. In this example, the spacing of the symmetrical copper windings is the same as the leg spacing L1 and is fixed. Such a fixed spacing configuration cannot match different print circuit board (PCB) layouts.

Embodiments of the present disclosure provide a transformer structure that can effectively reduce the size of a transformer, and improve power density and conversion efficiency. Further, the terminals of the transformer are not limited by the core size. The embodiment transformer structure can satisfy different layout requirements. Embodiments of the present disclosure may be applied in the field of information technology (IT), mining machine power supplies, power conversion systems, and so on.

Embodiments of the present disclosure will be described in the following in a specific context, i.e., a small volume transformer structure, which is merely used for illustration purposes. The term “small volume” should be understood as a relatively term. It is only used to indicate that the transformer structure helps reduce the size of a transformer. Hereinafter, various embodiments will be explained in detail with reference to the accompanying drawings.

In some embodiments, a transformer may include a pair of integrated magnetic cores, a plurality of secondary windings formed by metal sheets, insulating films placed between the metal sheets, epoxy boards placed in air gaps, and a plurality of primary windings formed by alpha (α) type coils connected in series-parallel. The integrated magnetic core may also be referred to as a “magnetic core” or “core” unless otherwise specified.

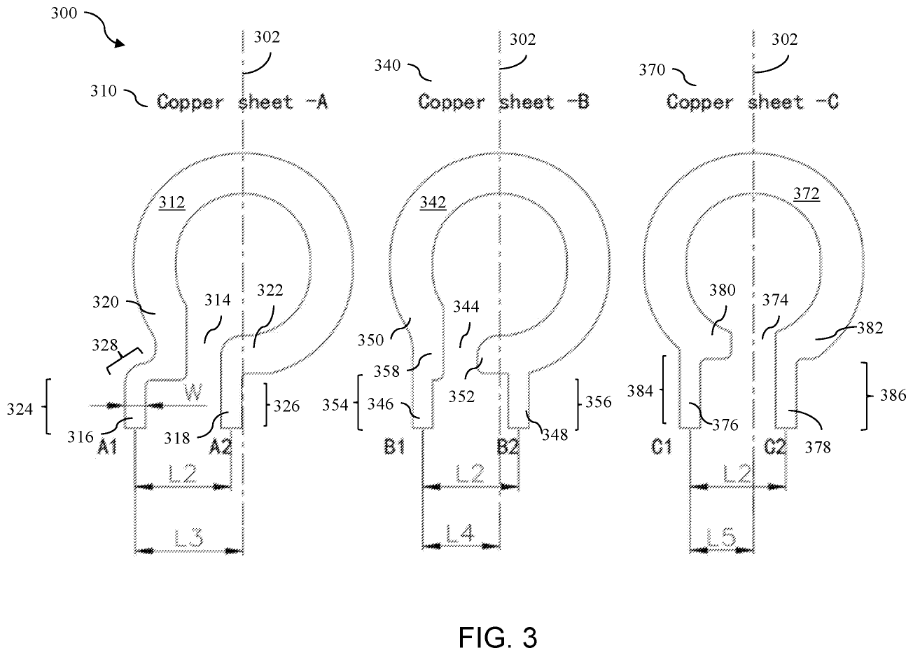

FIG. 3 is a schematic diagram 300 illustrating example metal sheets of three different sheet types in accordance with various embodiments of the present disclosure. The metal sheets may be used as the secondary windings of the core, and placed around the core legs. In some embodiments, the metal sheets may be made of copper, e.g., purple copper. In the following, a metal sheet made of copper is used as examples for illustration, and is referred to as a copper sheet. The metal sheets may have different sheet structures or sheet types. FIG. 3 illustrates example copper sheets of three different sheet types A, B and C, i.e., a copper sheet A 310, a copper sheet B 340, and a copper sheet C 370.

The copper sheet A 310 of the sheet type A has a main body 312 in a ring shape with an opening 314 on the lower portion of the main body 312, and two terminals A1 316 and A2 318 extending respectively downward from two ends 320 and 322 of the opening 314. The ring shape may also be referred to as a disc shape with a hole in the middle, or a donut shape. The terminals A1 316 and A2 318 extend along a centerline 302 of the ring shape. The centerline 302 may be viewed as a vertical centerline in this this example. When the copper sheet is placed around a leg of the core 100, the centerline 302 of the ring shape may be perpendicular to the line 132 in FIG. 1, i.e., perpendicular to the longitudinal direction of the core 100. Each of the terminals A1 316 and A2 318 has a portion at the end of the corresponding terminal, i.e., a portion 324, or a portion 326, that extends downward in parallel to the centerline 302. The two portions 324 and 326 (also referred to as vertical portions as they extend downward vertically) of the two terminals A1 316 and A2 318 each has a width W. A distance between the two terminals A1 316 and A2 318 is L2, i.e., the distance from a center of the terminal A1 316 to a center of the terminal A2 318 in a lateral direction (perpendicular to the centerline 302) of the terminals is L2. A distance from the terminal A1 316 to the centerline 302 of the ring shape is L3, i.e., the distance from the center of the terminal A1 316 in the lateral direction to the centerline 302 is L3. In this example, an edge of the terminal A2 318 is aligned with the centerline 302, and both the terminals A1 316 and A2 328 are at the one side of the centerline 302.

The copper sheet B 340 of the sheet type B has a main body 342 in the ring shape with an opening 344 on the lower portion of the main body 342, and two terminals B1 346 and B2 348 extending respectively downward from two ends 350 and 352 of the opening 344. The terminals B1 346 and B2 348 extend along the vertical centerline 302 of the ring shape. Each of the terminals B1 346 and B2 348 has a portion at the end of the corresponding terminal, i.e., a portion 354, or a portion 356, that extends downward in parallel to the centerline 302. The two portions 354 and 356 (also referred to as vertical portions) of the two terminals B1 346 and B2 348 each has a width W. A distance between the two terminals B1 346 and B2 348 is L2, i.e., the distance from a center of the terminal B1 346 to a center of the terminal B2 348 in a lateral direction of the terminals is L2. A distance from the terminal B1 346 to the centerline 302 of the ring shape is L4, i.e., the distance from the center of the terminal B1 346 to the centerline 302 in the lateral direction is L4. In this example, the two terminals B1 346 and B2 348 are located at two sides of the centerline 302.

The copper sheet C 370 of the sheet type C has a main body 372 in the ring shape with an opening 374 on the lower portion of the main body 372, and two terminals C1 376 and C2 378 extending respectively downward from two ends 380 and 382 of the opening 374. The terminals C1 376 and C2 378 extend along the vertical centerline 302 of the ring shape. Each of the terminals C1 376 and C2 378 has a portion at the end of the corresponding terminal, i.e., a portion 384, or a portion 386, that extends downward in parallel to the centerline 302. The two portions 384 and 386 (also referred to as vertical portions) of the two terminals C1 376 and C2 378 each has a width W. A distance between the two terminals C1 376 and C2 378 is L2, i.e., the distance from a center of the terminal C1 376 to a center of the terminal C2 378 in a lateral direction of the terminals is L2. A distance from the terminal C1 376 to the centerline 302 of the ring shape is L5, i.e., the distance from the center of the terminal C1 376 to the centerline 302 in the lateral direction is L5. L5, L4 and L3 are different from one another. In this example, the two terminals C1 376 and C2 378 are located at the two sides of the centerline 302.

The distance between the two terminals of each of the copper sheets A 310, B 340 and C 370 are the same, i.e., L2. All the terminals of the three copper sheets may have the same width, i.e., W. However, the respective first terminals (i.e., terminals 316, 346, and 376) of the copper sheets A 310, B 340 and C 370 have different distances to the centerline 302, or the respective second terminals (i.e., terminals 318, 348, and 378) of the copper sheets A 310, B 340 and C 370 have different distances to the centerline 302. The differences may be made by providing different openings 314, 344 and 374 on the ring shape, e.g., different positions or sizes of the openings. A terminal may have a transition portion between an end of an opening and a vertical portion of the terminal, which may be present as a result of manufacturing in order to obtain the required positions of the terminal while keeping the distances L2, and L3, L4 or L5. As an example, the terminal 316 may include a bent or arched transition portion 328 connecting the end 320 and the vertical portion 324. The terminal 318 may include a similar transition portion. As another example, the terminal 346 may include a transition portion 358 connecting the end 350 and the vertical portion 354, where the transition portion 358 has a width greater than W. The two terminals of each of the copper sheets 310, 340 and 370 are not symmetric around the centerline 302.

As used herein, the term “ring” is used merely for description purposes to describe a general shape of the metal sheets. The cross section of the ring shape may have a shape of circles or ovals. The size of the ring shape (e.g., the hole in the middle of the ring shape, the diameters of the ring shapes) and the general shape of the ring shape need to match the core (e.g., the size of the core, the leg spacing, and so on) in order to place the metal sheets around the legs of the core. The three sheet types use the same ring shape (including size) but with different openings and terminals provided on the ring shape. L1-L5 and/or W of the sheet types may be collectively referred to as a set of sheet parameters of the sheet types.

The sheet structures/types as described above with respect to FIG. 3 can be used to solve the above problem caused by the fixed spacing between two adjacent legs/pillars of the integrated magnetic core, and thus avoid the terminals of the windings from being limited by the restriction of the integrated magnetic core. As a result, the winding spacing of the windings is not limited by the leg spacing of the core. The metal sheets may be customized according to the needs of the winding spacing to satisfy different PCB layout requirements, e.g., one or more of the distances L2-L5. Further, the copper sheets are more beneficial for current carrying and heat dissipation, which improves the thermal performance and efficiency of the transformer. In addition, with various combinations of the copper sheets, a single-turn winding formed by one copper sheet may be connected in series to obtain a double-turn winding formed by two copper sheets.

According to some embodiments of the present disclosure, the sheet types A, B and C may be utilized to form windings and used as secondary windings for transformers. Taking the core 100 having three legs as an example, the following three windings may be formed to place on the three legs, respectively. Those of ordinary skill in the art would recognize that various modifications, embodiments and alternations may be applicable to form the windings based on the core to be used and PCB layout requirements, without departing from the spirit and principle of the present disclosure.

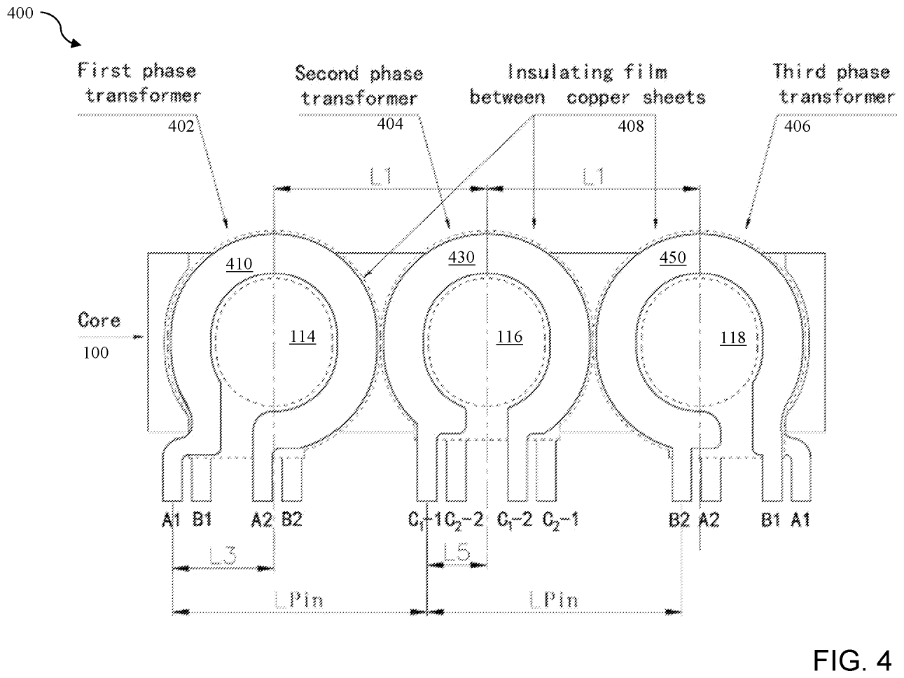

In some embodiments, a first winding (e.g., a winding 410 in FIG. 4 in the following) may include the copper sheet A 310 and the copper sheet B 340 that are stacked with the copper sheet A 310 on top of the copper sheet B 340. Specifically, a rear surface of the copper sheet A 310 is disposed on top of a front surface of the copper sheet B 340, i.e., the rear surface of the copper sheet A 310 faces the front surface of the copper sheet B 340. An insulating film may be disposed between the copper sheet A 310 and the copper sheet B 340.

In some embodiments, a second winding (e.g., a winding 430 in FIG. 4 in the following) may include two copper sheets C 370 (i.e., a first copper sheet C 370 and a second copper sheet C 370), where the two copper sheets C 370 are stacked with the first copper sheet C 370 on top of the second copper sheet C 370 that is flipped (front-rear). Specifically, a rear surface of the first copper sheet C 370 is disposed on top of a rear surface of the second copper sheet C 370, i.e., the rear surface of the first copper sheet C 370 faces the rear surface of the second copper sheet C 370. An insulating film may be disposed between the two copper sheets C 370.

In some embodiments, a third winding (e.g., a winding 450 in FIG. 4 in the following) may include the copper sheet A 310 and the copper sheet B 340 that are flipped and stacked with the flipped copper sheet A 310 on top of the flipped copper sheet B 340. That is, both the copper sheet A 310 and the copper sheet B 340 are flipped by 180 degrees (front-rear), and the flipped copper sheet A 310 is stacked on top of the flipped copper sheet B 340. Specifically, the front surface of the copper sheet A 310 is disposed on top of the rear surface of the copper sheet B 340, i.e., the front surface of the copper sheet A 310 faces the rear surface of the copper sheet B 340. An insulating film may be disposed between the copper sheet A 310 and the copper sheet B 340. The embodiment first, second and third windings may be used as secondary windings of a transformer.

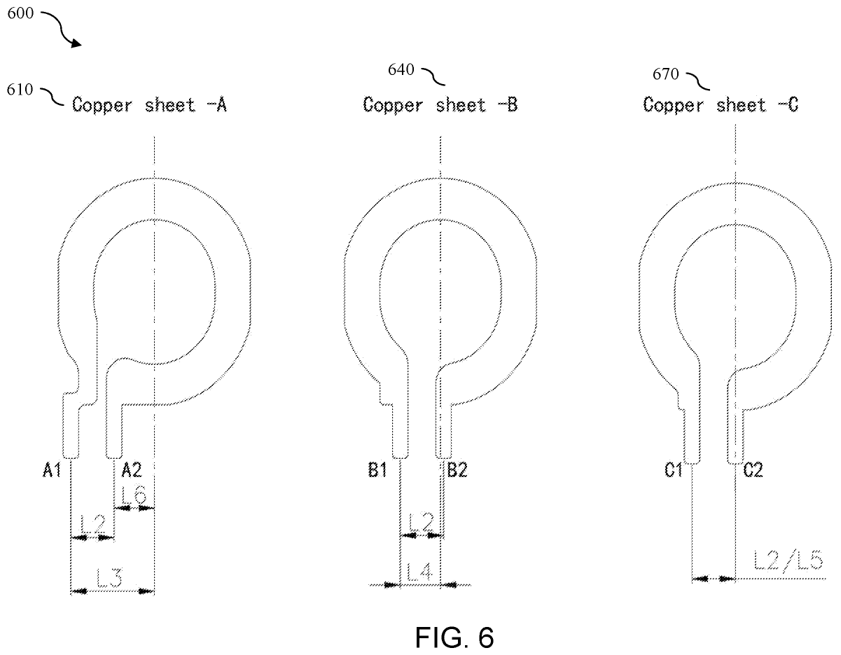

In some embodiments, based on PCB layout requirements, the core, and other possible requirements (collectively referred to as winding requirements thereafter), the parameters L1-L5 and/or W of the sheet types may be determined, and then copper sheets of the sheet types A, B and C may be made or selected based on the parameters. A certain set of winding requirements may correspond to a set of sheet parameters, such as L1-L5, W and other parameters, such as L6 as shown in FIG. 6. In one example, the width of the terminals W may be determined based on the core/leg size. Various sheet types may be designed and constructed based on various winding requirements, and used to form various windings, e.g., the above first, second and third windings.

FIG. 4 is a diagram of a top view of an example transformer structure 400 in accordance with various embodiments of the present disclosure. The transformer structure 400 includes a first phase transformer 402, a second phase transformer 404 and a third phase transformer 406, which are formed using the core 100 as described with respect to FIG. 1, where secondary windings are formed by using the above described three windings.

In this example, the first phase transformer 402 includes the first winding (labeled herein with 410) placed around the core leg 114 of the core 100. As described above, the first winding 410 includes the copper sheet A 310 having two terminals A1 and A2, and the copper sheet B 340 having two terminals B1 and B2, where the copper sheet A 310 is stacked on top of the copper sheet B 340. An insulating film 408 (dashed line) is placed between the copper sheet A 310 and the copper sheet B 340.

The second phase transformer 404 includes the second winding (labelled herein with 430) placed around the core leg 116 of the core 100. As described above, the second winding 430 includes the first copper sheet C 370 having two terminals (C₁-1 and C₁-2 in this example), and the second copper sheet C 370 having two terminals (C₂-1 and C₂-2 in this example), where the second copper sheet C 370 is flipped, and the first copper sheet C 370 is stacked on top of the flipped second copper sheet C 370. An insulating film 408 is placed between the first copper sheet C 370 and the flipped second copper sheet C 370.

The third phase transformer 406 includes the third winding (labeled herein with 450) placed around the core leg 118 of the core 100. As described above, the third winding 450 includes the copper sheet A 310 having the two terminals A1 and A2, and the copper sheet B 340 having the two terminals B1 and B2, where both the copper sheet A 310 and the copper sheet B 340 are flipped and stacked, with the flipped copper sheet A 310 stacked on top of the flipped copper sheet B 340. An insulating film 408 is placed between the flipped copper sheet A 310 and the flipped copper sheet B 340.

In the transformer structure 400, the leg spacing of the core 100 is L1. Distances between the terminals A1 and A2, terminals B1 and B2, terminals C₁-1 and C₁-2, and terminals C₂-1 and C₂-2 are the same, which are L2. The winding spacing is L_{Pin}, which is the distance between the terminal A1 of the first winding 410 and the terminal C₁-1 of the second winding 430, and the distance between the terminal C₁-1 of the second winding 430 and the terminal B2 of the third winding 450. The terminals may be directly welded to a printed circuit board (PCB). The distance from the terminal A1 of the first winding 410 to the centerline is L3, and the distance from the terminal C₁-1 of the second winding 430 to the centerline is L5. Therefore, it can be seen that ΔL=L_{Pin}−L1=L3−L5, where ΔL is the difference between the winding spacing L_{Pin} and the leg spacing L1, which is also equal to the difference between L3 and L5. By changing ΔL, i.e., the difference between L3 and L5, the winding spacing L_{Pin} can be adjusted, to satisfy different PCB layout requirements.

The insulating films 408 may be in a shape similar to that of the ring shape of the copper sheets, and may have a larger surface than the ring shape for the convenience of being placed between two copper sheets.

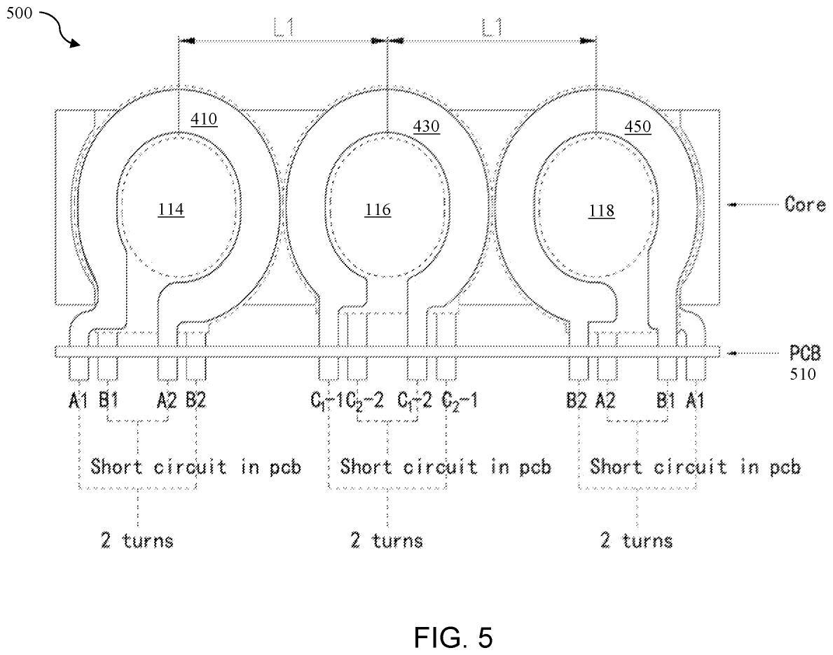

FIG. 5 is a diagram of a top view of another example transformer structure 500 in accordance with various embodiments of the present disclosure, highlighting connection of terminals of the copper sheets (as indicated by dashed lines in FIG. 5). The transformer structure 500 is similar to the transformer structure 400 in FIG. 4. Similar components in FIG. 5 reuse the numeral numbers in FIG. 4 for description simplicity. The transformer structure 500 includes the first winding 410, the second winding 430 and the third winding 450 placed around the legs 114, 116 and 118 of the core 100, respectively.

In the example of FIG. 5, a PCB 510 may be used to connect the windings. As an example, the terminals B1 and A2 of the first winding 410 may be connected via the PCB 510, resulting in two turns of winding between the terminals A1 and B2 of the first winding 410.

These two turns may form the secondary winding of the first phase transformer 402. The terminal A1 of the first winding 410 may serve as a starting point of the two turns, and the terminal B2 of the first winding 410 may be the ending point of the two turns. In other words, the terminals A1 and B2 of the first winding 410 may be the two ends/terminals of the first winding 410.

In an example, the terminals C₂-2 and C₁-2 of the second winding 430 may be connected (indicated by the dashed line) via the PCB 510, resulting in two turns of winding between the terminals C₁-1 and C₂-1 of the second winding 430. These two turns may form the secondary winding of the second phase transformer 404 in FIG. 4. As indicated by the dashed lines, the terminal C₁-1 of the second winding 430 may serve as a starting point of the two turns, and the terminal C2-1 of the second winding 430 may be the ending point of the two turns. In other words, the terminals C₁-1 and C₂-1 of the second winding 430 may be the two ends/terminals of the second winding 430.

In an example, the terminals A2 and B1 of the third winding 450 may be connected via the PCB 510, resulting in two turns of winding between the terminals B2 and A1 of the third winding 450. These two turns may form the secondary winding of the third phase transformer 406 in FIG. 4. The terminal B2 of the third winding 450 may serve as a starting point of the two turns, and the terminal A1 of the third winding 450 may be the ending point of the two turns. In other words, the terminals B2 and A1 of the third winding 450 may be the two ends/terminals of the third winding 450.

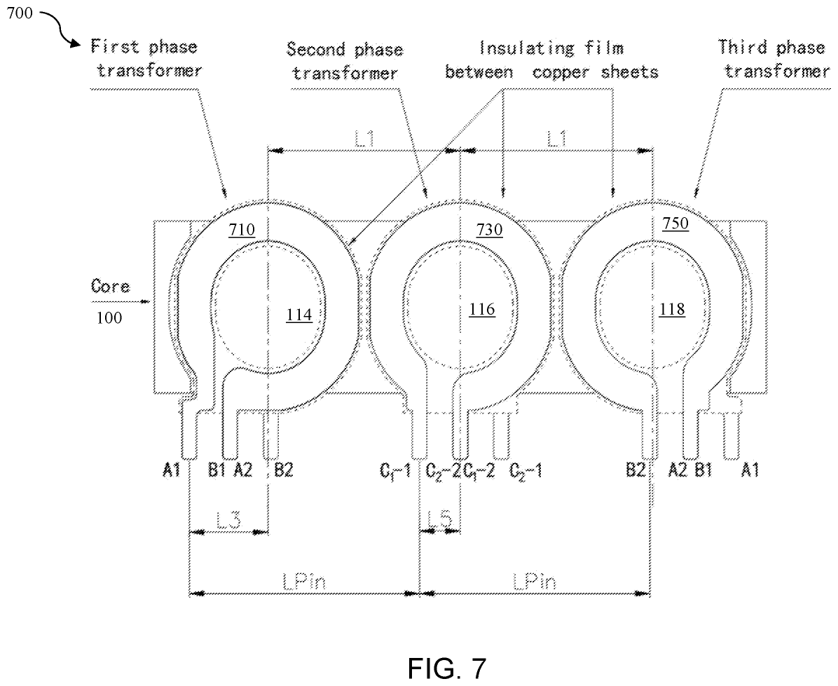

FIG. 6 is a diagram 600 illustrating another example of metal sheets of the sheet types A, B and C in accordance with various embodiments of the present disclosure. FIG. 6 illustrates a copper sheet A 610 of the sheet type A, a copper sheet B 640 of the sheet type B, and a copper sheet C 670 of the sheet type C, which have a different set of parameters than that shown in FIG. 3. Specifically, the copper sheets 610, 640 and 670 are similar to the copper sheets 310, 340, and 370, except that, in this example of FIG. 6, L6=L4 and L5=L2. That is, the distances between the terminals A1 and A2 of the copper sheet 610, between the terminals B1 and B2 of the copper sheet 640, and between the terminals C1 and C2 of the copper sheet 670 are the same, i.e., L2. However, the distance L6 from the terminal A2 to the centerline of the ring shape is the same as the distance L4 from the terminal B1 to the centerline of the ring shape. Further, the distance L5 from the terminal C1 to the centerline of the ring shape is equal to L2. The copper sheets in FIG. 6 have different openings and terminals compared with that in FIG. 3. With such a different set of parameters, the first, second and third windings formed using these metal sheets 610, 640 and 670 are different than those shown in FIG. 4. FIG. 7 shows an example.

FIG. 7 is a diagram of a top view of another example transformer structure 700 in accordance with various embodiments of the present disclosure, where secondary windings are formed using the metal sheets as described with respect to FIG. 6. Similar to FIG. 4, the transformer structure 700 includes a first phase transformer formed by a first winding 710 around the core leg 114 of the core 100, a second phase transformer formed by a second winding 730 around the core leg 116 of the core 100, and a third phase transformer formed by a third winding 750 around the core leg 118 of the core 100.

Similar to the windings described with respect to FIG. 4, the first winding 710 includes the copper sheet A 610 and the copper sheet B 640, with the copper sheet A 610 stacked on top of the copper sheet B 640. The second winding 730 includes two copper sheets C 670 (i.e., a first copper sheet C 670 and a second copper sheet C 670), with the first copper sheet C 670 stacked on the flipped second copper sheet C 670. The third winding 750 includes the copper sheet A 610 and the copper sheet B 640, which are both flipped and stacked with the flipped copper sheet A 610 on top of the flipped copper sheet B 640. An insulating film is disposed between two stacked copper sheets for the three phases.

With the setting L6=L4 and L5=L2, the terminals B1 and A2 of the first winding 710 overlap each other, the terminals C₂-2 and C₁-2 of the second winding 730 overlap each other, and the terminals A2 and B1 of the third winding 750 overlap each other. In this example, the terminals C₁-1 and C₂-1 of the second winding 730 are symmetric with respect to the centerline of the ring shape.

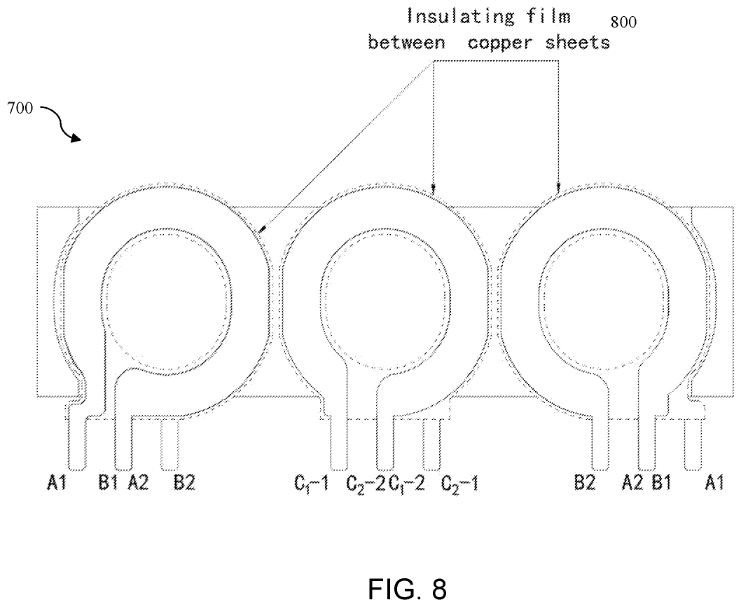

FIG. 8 is a diagram of the example transformer structure 700, highlighting the insulating films 800 disposed between copper sheets, in accordance with various embodiments of the present disclosure. As an example, an insulating film 800 may be placed between the copper sheet A 610 and the copper sheet B 640 of the first winding 710, an insulating film 800 may be placed between the two copper sheets C 670 of the second winding 730, and an insulating film 800 may be placed between the copper sheet A 610 and the copper sheet B 640 of the third winding 750. In some embodiments, an insulating film may have a thickness of 0.1 mm or less, and have properties meeting the requirements of high temperature resistance 150° C. and voltage resistance 3 KV or more, which saves the thickness size while avoiding short circuit between turns. The shape and size of an insulating film may be similar to that of a copper sheet, and its size may be greater than the copper sheet, e.g., extending out from the circumference of the copper sheet by about 0.5-1 mm, for easy attaching/pasting/gluing the insulating film.

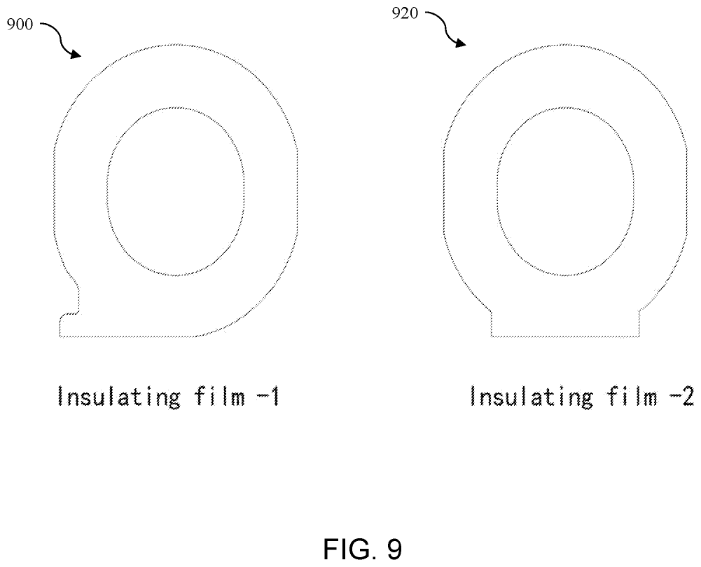

FIG. 9 is a diagram illustrating two different insulating films 900 and 920 in accordance with various embodiments of the present disclosure. In this example, the insulating film 900 is asymmetrical with respect to a centerline of the ring shape of the copper sheets. The insulating film 920 is symmetrical with respect to the centerline of the ring shape of the copper sheets.

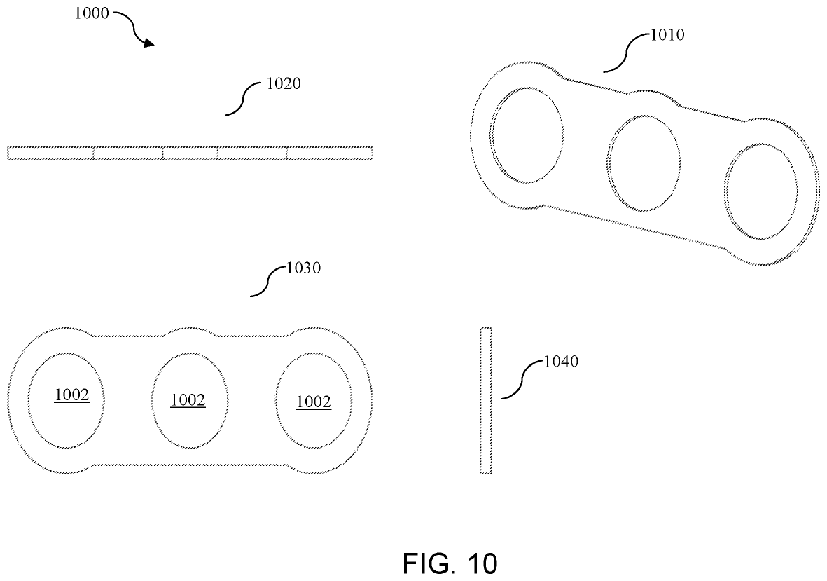

Arranging an air gap between two magnetic cores of a transformer can reduce the risk of magnetic saturation in application of the transformer. Placing an epoxy board in the air gap can prevent the primary and secondary windings from occupying the air gap (the windings stay away from the air gap). This can effectively reduce the winding eddy current loss and improve efficiency. An epoxy board may have a structure/shape that is similar to a magnetic core for ease of assembly. FIG. 10 is a diagram of an example epoxy board 1000 configured for magnetic cores having a structure of the core 100 as described with respect to FIG. 1, in accordance with various embodiments of the present disclosure. FIG. 10 provides a perspective view 1010, a front view 1020, a top view 1030, and a side view 1040 of the epoxy board 1000. The epoxy board 1000 may be used between two cores 100, which are stacked with the three legs of one core 100 facing toward the three legs of the other core 100. The epoxy board 1000 has three holes 1002 matching the three legs of each of the two cores 100.

FIG. 11 is a diagram of an example primary winding 1100 of a transformer in accordance with various embodiments of the present disclosure. FIG. 11 includes a perspective view 1110, a left side view 1120, a top view 1130 and a front view 1140 of the primary winding 1100. The primary winding 1100 may be made by use of three-layer insulated wires or other insulated wires that are wound around. The primary winding 1100 may include two or more a (alpha) type windings (also referred to as a type primary coils) connected in series, which can be flexible in providing a required number of turns, shorten the path of the series connection between the windings and ensure the flatness of the windings. This configuration also facilitates coupling of the primary winding with the secondary side windings. The primary winding 1100 as shown includes two a type primary coils 1112 connected in series by a series line 1114. The series line 1114 may be integrated with the a type primary coils 1112. The length of the series line 1114 may be adjusted in order to satisfy different requirements for spans (i.e., P_COIL), which is a distance between the two a type primary coils 1112. It should be noted that each individual a type winding 1112 of the a type windings connected in series may have a different number of turns.

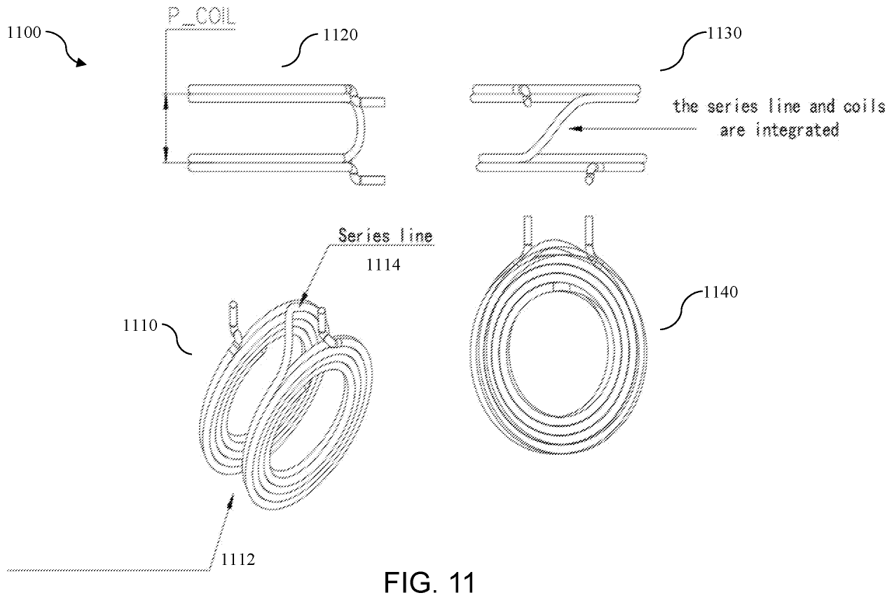

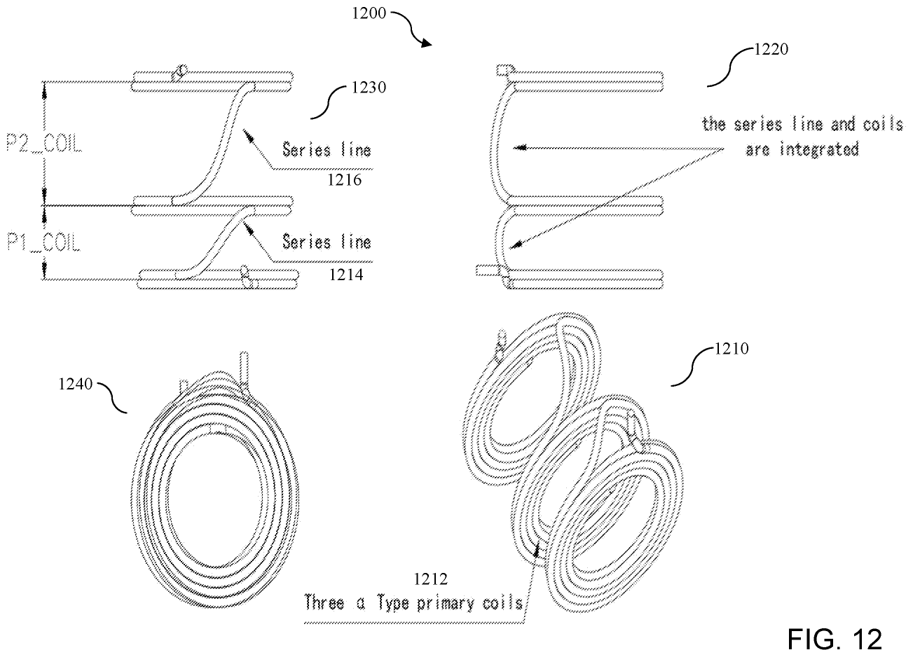

FIG. 12 is a diagram of another example primary winding 1200 of a transformer in accordance with various embodiments of the present disclosure. FIG. 12 includes a perspective view 1210, a right side view 1220, a top view 1230 and a front view 1240 of the primary winding 1200. The primary winding 1200 may be made by use of three-layer insulated wires or other insulated wires that are wound around. As shown, the primary winding 1200 includes three a type primary coils 1212 connected in series by series lines 1214 and 1216. The series lines 1214 and 1216 may be integrated with the a type primary coils 1212. The length of the series lines 1214 and 1216 may each be adjusted in order to satisfy different requirements for the spans (i.e., P1_COIL, P2_COIL).

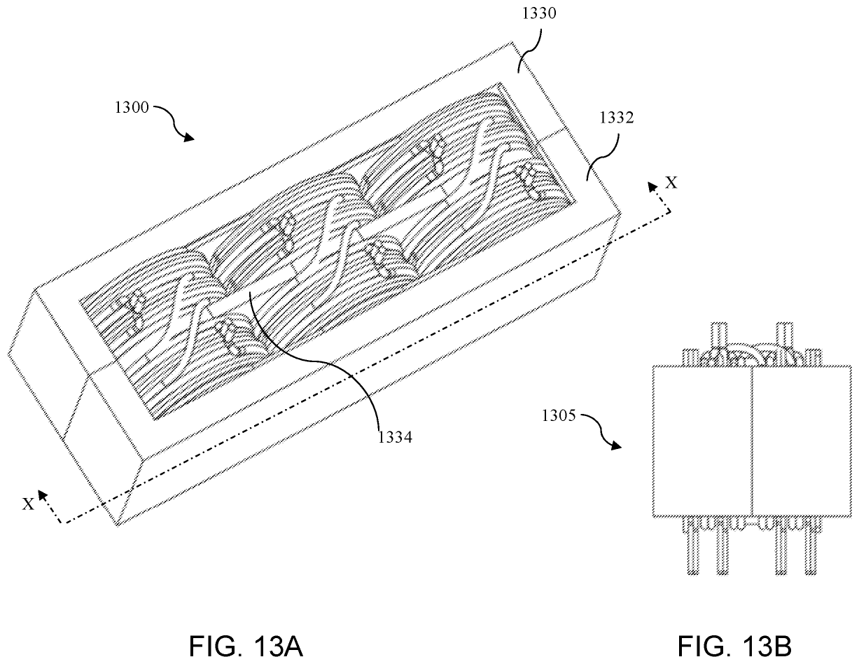

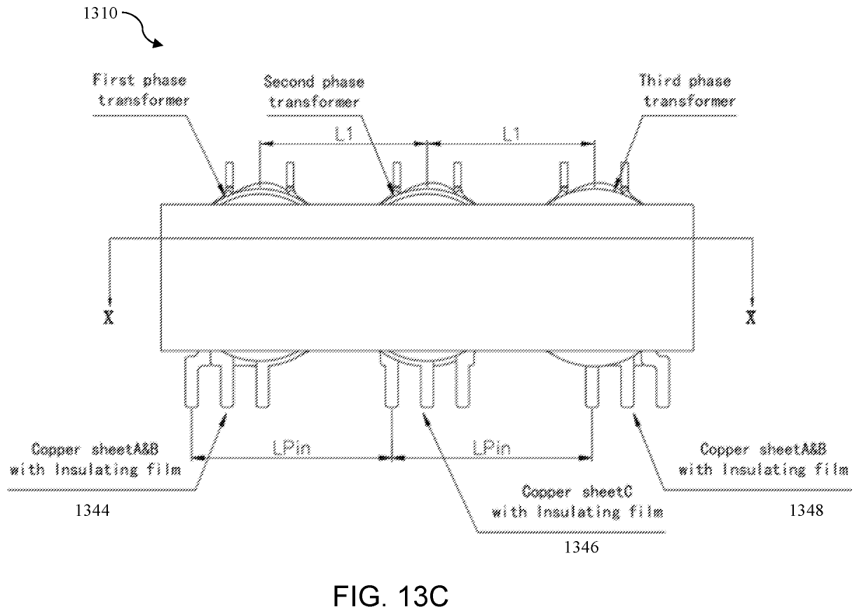

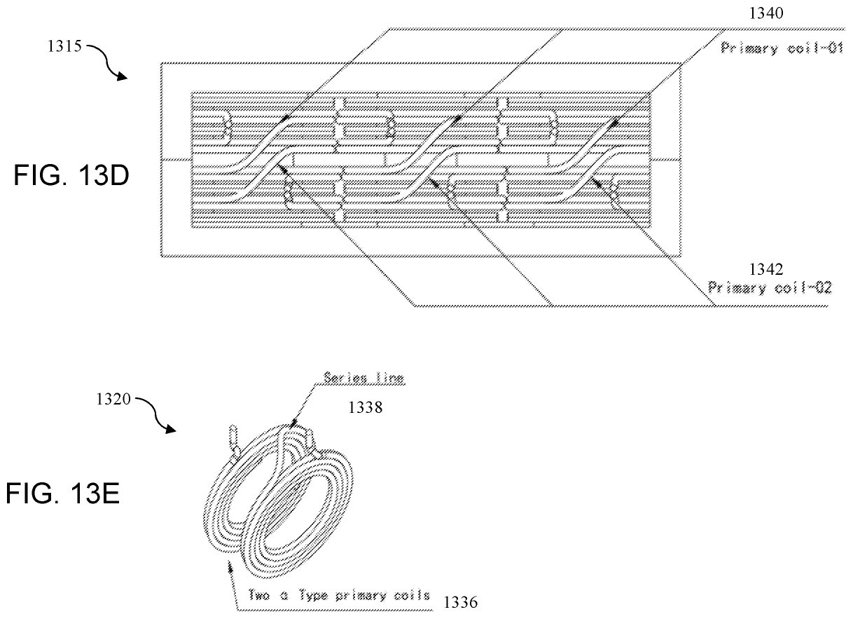

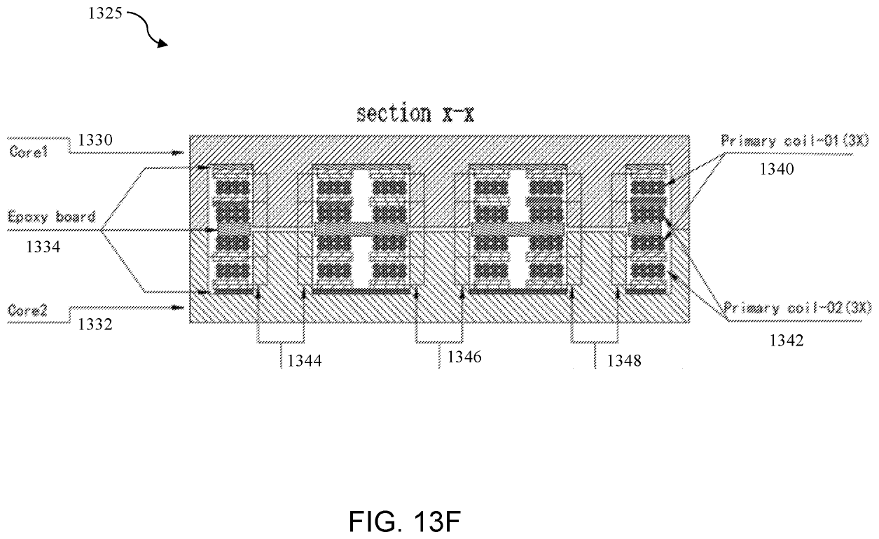

FIGS. 13A-13F illustrate an example transformer 1300 in accordance with various embodiments of the present disclosure. The transformer 1300 generally includes a pair of magnetic cores, primary windings, secondary windings formed by copper sheets, insulating films, and epoxy boards. FIG. 13A is a diagram of the transformer 1300 in a top perspective view. FIG. 13B is a side perspective view 1305 of the transformer 1300. FIG. 13C is a front view 1310 of the transformer 1300. FIG. 13D is a top view 1315 of the transformer 1300. FIG. 13E is an example primary winding 1320 of the transformer 1300. FIG. 13F is a cross sectional view 1325 of the transformer 1300 along a line XX.

The transformer 1300 will be described in the following with reference to FIGS. 13A-13F and FIG. 1. The transformer 1300 includes a core1 1330 and a core2 1332, each of which is similar to the core 100 as described above with respect to FIG. 1. The core 100 is merely used herein as an example for illustration purposes, and other cores may also be used to form a transformer in a similar way. The core1 1330 and core2 1332 may be arranged side by side or stacked, with the three legs of the core1 1330 facing toward the three legs of the core2 1332, respectively. An epoxy board 1334 may be arranged at the air gap between the core1 1330 and core2 1332. The epoxy board 1334 may be similar to the epoxy board 1000 as described above with respect to FIG. 10. An epoxy board 1334 may also be arranged on the bottom of each core (e.g., on the surface 120 of the core 100 in FIG. 1), as shown in FIG. 13F.

The transformer 1300 may include a first phase transformer, a second phase transformer, and a third phase transformer formed by use of the first legs 114, the second legs 116 and the third legs 118 of the core1 1330 and core2 1332, respectively. The primary windings and secondary windings may be alternately arranged on the legs, e.g., in an order of a secondary winding, a first primary winding 1340 (also referred to as primary coil-01 in the figures), a secondary winding, a second primary winding 1342 (also referred to as primary coil-02 in the figures), an epoxy board 1334, a first primary winding 1340, a secondary winding, a second primary winding 1342, and a secondary winding, as shown in FIG. 13F.

The first, second and third phase transformers use different secondary windings 1344, 1346 and 1348, respectively, similar to those as discussed above with respect to FIG. 4 and FIG. 7. The secondary windings 1344, 1346 and 1348 may be similar respectively to the windings 710, 730 and 750 as described with respect to FIG. 7. The secondary windings 1344, 1346 and 1348 may also be similar respectively to the windings 410, 430 and 450 as described with respect to FIG. 4. An insulating film is placed between two copper sheets forming a secondary winding.

Each primary winding (1340 and 1342) of the transformer 1300 may be similar to the primary winding 1100 as described with respect to FIG. 11, i.e., including two a type primary coils 1336 that are connected in series by a series line 1338, as shown in FIG. 13E. The first primary windings 1340 and the second primary winding 1342 may be connected in parallel or in series, depending various applications.

In this example transformer 1300, by using the primary windings (formed by two a type coils connected in series) and secondary windings (formed by copper sheets) that are interleaved or alternated, the magnetic coupling of the transformer 1300 may be ensured. Two sets of primary windings (e.g., the first primary windings 1340 and the second primary winding 1342) may be connected in parallel to meet the requirement of current carrying. The epoxy board 1334 arranged at the air gap between the cores keeps the primary windings away from the air gap, which reduces the eddy current loss. The epoxy board 1334 arranged at the bottom of the cores and copper sheets of secondary windings reduces the eddy current loss of the copper sheets. The insulating film affixed between two adjacent copper sheets prevents the turns made of the copper sheets from being short-circuited. The transformer 1300 has advantages of having a small volume and high efficiency, and may be customized to meet different PCB layout requirements, e.g., by adjusting the terminals of the copper sheets. The transformer 1300 may be utilized to provide high power density and high efficiency power supplies.

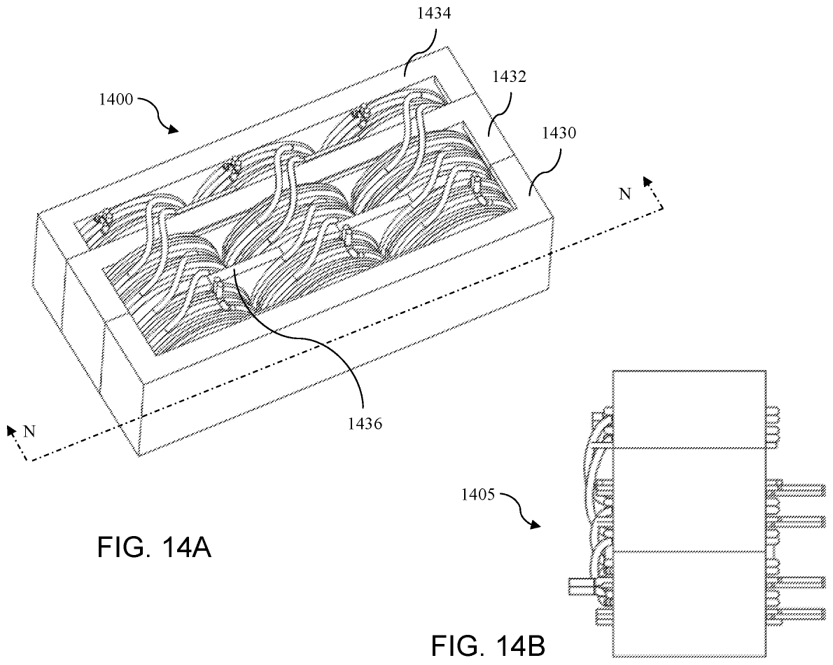

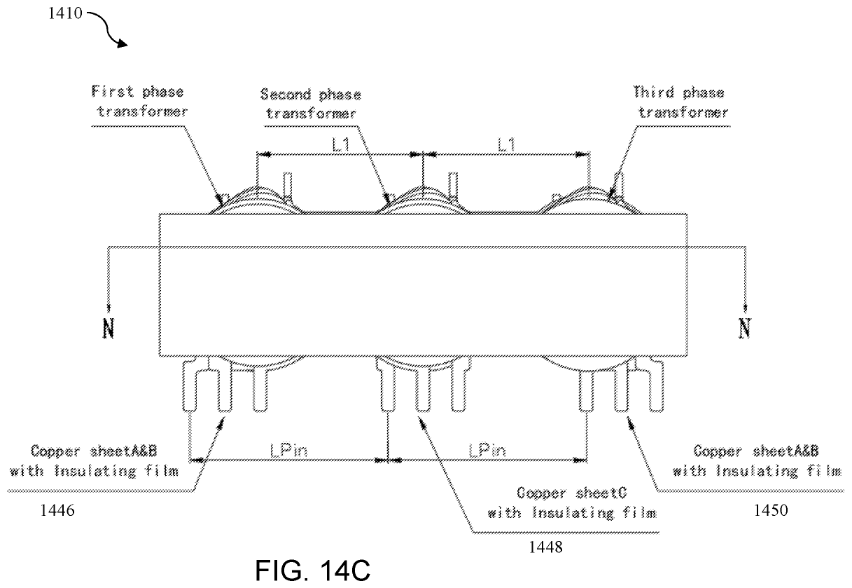

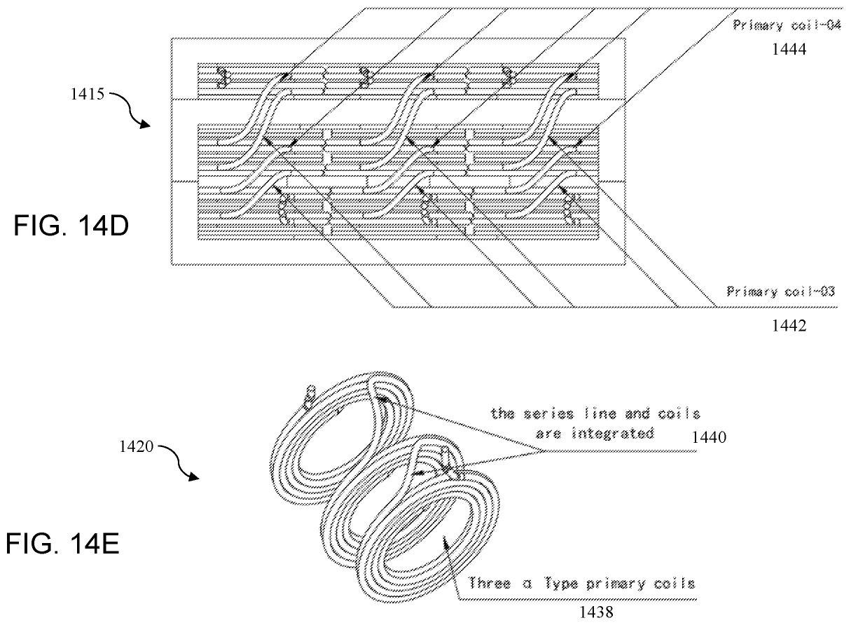

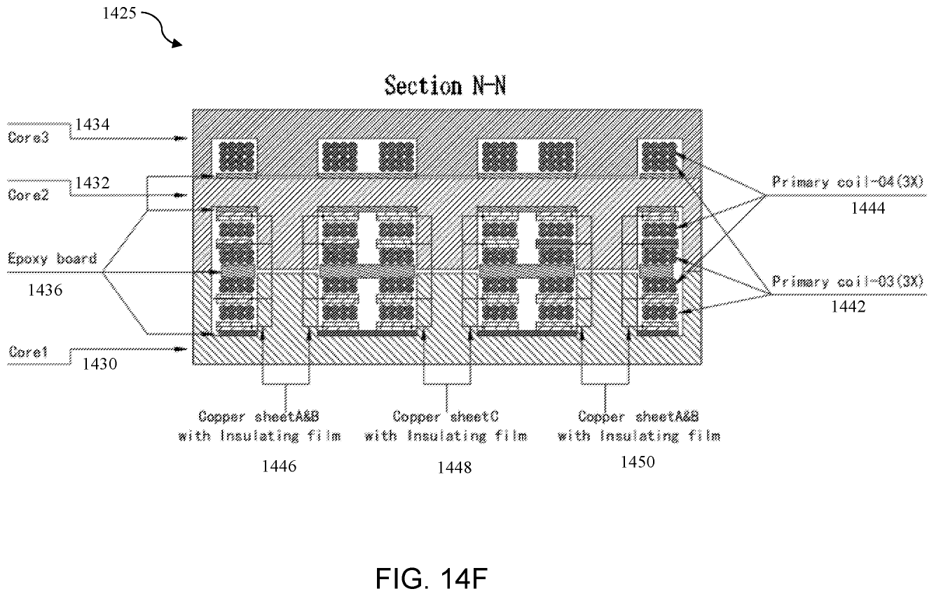

FIGS. 14A-14F illustrate another example transformer 1400 in accordance with various embodiments of the present disclosure. FIG. 14A is a diagram of the transformer 1400 in a top front perspective view. FIG. 14B is a side view 1405 of the transformer 1400. FIG. 14C is a front view 1410 of the transformer 1400. FIG. 14D is a top view 1415 of the transformer 1400. FIG. 14E is an example primary winding 1420 of the transformer 1400. FIG. 14F is a cross sectional view 1425 of the transformer 1400 along a line NN. The transformer 1400 is similar to the transformer 1300 as described above with respect to FIG. 13, and a difference is that the transformer 1400 includes three cores, and the primary winding is similar to the primary winding 1200 as described above with respect to FIG. 12.

The transformer 1400 includes a core1 1430, a core2 1432 and a core3 1434, with an epoxy board 1436 arranged at the air gap between the cores 1430 and 1432. Another epoxy board 1436 may be arranged between the cores 1432 and 1434 as shown in FIG. 14F. Each of the cores is similar to the core 100 as described above with respect to FIG. 1. The three cores are arranged side by side or stacked, with the core2 1432 facing toward the core1 1430 and away from the core 1434. The epoxy boards 1436 may be similar to the epoxy board 1000 as described above with respect to FIG. 10. An epoxy board 1436 may also be arranged on the bottom of a core (e.g., on the surface 120 of the core 100 in FIG. 1), as shown in FIG. 14F.

The primary windings and secondary windings may be alternately arranged on the cores, similar to the transformer 1300 as described above. Different secondary windings 1446, 1448 and 1450 are used in different phase transformers, which are similar to the respective windings 710, 730 and 750 as described with respect to FIG. 7. An insulating film is placed between two copper sheets forming a secondary winding.

Each primary winding (1442 and 1444) of the transformer 1400 may be similar to the primary winding 1200 as described with respect to FIG. 12, i.e., including three a type primary coils 1438 that are connected in series by series lines 1440, as shown in FIG. 14E. The first primary windings 1442 and the second primary winding 1444 may be connected in series or in parallel.

The transformer 1400 has a small volume and high efficiency, and is customizable to meet different PCB layout requirements, e.g., by adjusting the terminals of the copper sheets. The transformer 1400 may be utilized to provide high power density and high efficiency power supplies.

In some embodiments, a transformer and an electronic component, e.g., a capacitor or an inductor, may be integrated together to share a core. This can reduce the size of a power conversion circuit, and enhances power efficiency.

In some embodiments, an electronic component may be integrated with a secondary winding, e.g., the secondary winding 410, 430, or 450 as illustrated in FIG. 4. As an example, a capacitor, e.g., a secondary side resonant capacitor, may be disposed on a terminal (referred to as a winding terminal) of the secondary winding, e.g., the terminal A1 or B2 of the secondary winding 410, the terminal C₁-1 or C₂-1 of the secondary winding 430, or the terminal B2 or A1 of the secondary winding 450. An insulating layer may be disposed between the capacitor and the terminal of the secondary winding on which the capacitor is disposed. The capacitor may have a first terminal connected to the winding terminal of the secondary winding, and a second terminal may be used to connect to an external circuit. Those of ordinary skill in the art would recognize that various methods or techniques may be used to integrate the capacitor with the secondary winding, and the capacitor may be replaced by other applicable components.

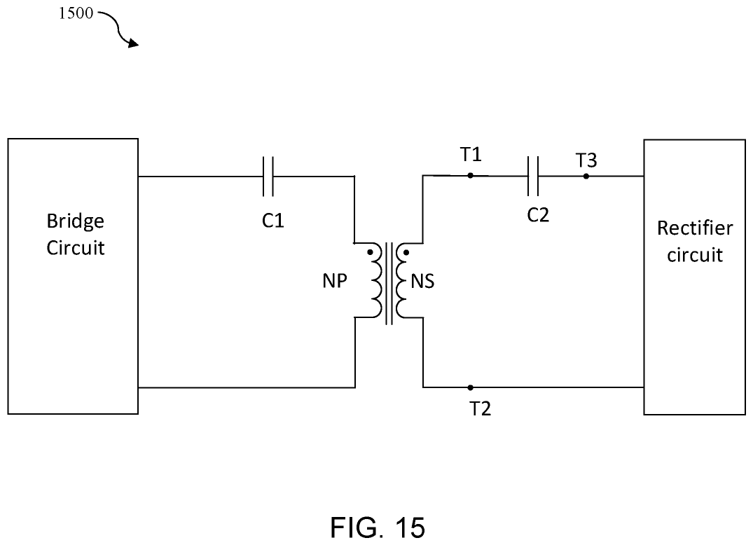

FIG. 15 is a schematic diagram of an example circuit 1500 that may be used in a power supply circuit. The circuit 1500 includes a transformer having a primary side winding NP and a secondary side winding NS. The secondary side winding NS has two winding terminals T1 and T2. A secondary side resonant capacitor C2 is connected between the terminal T2 and a rectifier circuit in series. The secondary side winding NS may be any of the embodiment secondary winding as described above. The secondary side resonant capacitor C2 may be integrated on the terminal T1 of the secondary side winding NS, and connected to the terminal T1 in series. In this case, the other terminal of the capacitor C1, i.e., T3, may be used to connect to an external circuit. Thus, the transformer may be connected to the external circuit through the terminals T3 and T2. Integrating the capacitor C1 with the secondary side winding NS can simplify the circuit on the secondary side.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A transformer comprising a first structure, the first structure comprising:
a core comprising a first leg, a second leg, and a third leg disposed between the first leg and the second leg;
a first secondary winding disposed around the first leg, the first secondary winding comprising a first copper sheet of a first sheet type and a second copper sheet of a second sheet type, the first copper sheet and the second copper sheet being stacked with a rear surface of the first copper sheet disposed on top of a front surface of the second copper sheet, the first sheet type comprising a first body in a ring shape with a first opening, and a first terminal and a second terminal extending respectively from two ends of the first opening along a centerline of the ring shape, and the second sheet type comprising a second body in the ring shape with a second opening, and a first terminal and a second terminal extending respectively from two ends of the second opening along the centerline;
a second secondary winding disposed around the second leg, the second secondary winding comprising a third copper sheet of the first sheet type and a fourth copper sheet of the second sheet type, the third copper sheet and the fourth copper sheet being stacked with a front surface of the third copper sheet disposed on top of a rear surface of the fourth copper sheet; and
a third secondary winding disposed around the third leg, the third secondary winding comprising a fifth copper sheet and a sixth copper sheet of a third sheet type, the fifth copper sheet and the sixth copper sheet being stacked with a rear surface of the fifth copper sheet disposed on top of a rear surface of the sixth copper sheet, the third sheet type comprising a third body in the ring shape with a third opening, and a first terminal and a second terminal extending respectively from two ends of the third opening along the centerline; and
wherein:
respective distances between first terminals and second terminals of the first, second and third sheet types are same; and
respective distances from the first terminals or the second terminals of the first, second and third sheet types to the centerline of the ring shape are different from one another, centerlines of the first to sixth copper sheets being perpendicular to the longitudinal direction of the core.

2. The transformer of claim 1, further comprising:
a first insulating film disposed between the first copper sheet and the second copper sheet of the first secondary winding;
a second insulating film disposed between the third copper sheet and the fourth copper sheet of the second secondary winding; and
a third insulating film disposed between the fifth copper sheet and the sixth copper sheet of the third secondary winding.

3. The transformer of claim 1, wherein a distance between the first terminal of the second sheet type and the centerline is same as a distance between the second terminal of the first sheet type and the centerline, and a distance between the first terminal of the third sheet type and the centerline is same as a distance between the first terminal and the second terminal of the third sheet type.

4. The transformer of claim 1, wherein the first terminal of each of the first sheet type, the second sheet type or the third sheet type is farther from the centerline than the second terminal of each of the first sheet type, the second sheet type or the third first sheet type.

5. The transformer of claim 1, wherein the first leg, the second leg and the third leg are evenly spaced at a first distance.

6. The transformer of claim 5, wherein a second distance between the first terminal of the first copper sheet and the first terminal of the fifth copper sheet is same as that between the first terminal of the fifth copper sheet and the first terminal of the third copper sheet, the second distance different from the first distance.

7. The transformer of claim 1, wherein the first terminals and the second terminals of the first sheet type, the second sheet type and the third sheet type have a same width.

8. The transformer of claim 1, wherein the core further comprises two side portions encompassing the first leg, the second leg and the third leg in between.

9. The transformer of claim 1, further comprising:
an electronic component or device disposed on the first terminal or the second terminal of the first, second, third, fourth, fifth or sixth copper sheet, the electronic component or device comprising a first pad electrically coupled to the first terminal or the second terminal and a second pad serving as a terminal of a corresponding winding.

10. The transformer of claim 1, further comprising:
a first primary winding and a fourth secondary winding disposed around the first leg, the first primary winding stacked between the first secondary winding and the fourth secondary winding;
a second primary winding and a fifth secondary winding disposed around the second leg, the second primary winding stacked between the second secondary winding and the fifth secondary winding; and
a third primary winding and a sixth secondary winding disposed around the third leg, the third primary winding stacked between the third secondary winding and the sixth secondary winding, wherein the fourth secondary winding, the fifth secondary winding and the sixth secondary winding are same as the first secondary winding, the second secondary winding and the third secondary winding, respectively.

11. The transformer of claim 1, further comprising a second structure identical to the first structure, the second structure being stacked with the first structure such that the first, second and third legs of the second structure face toward the first, second and third legs of the first structure, respectively; and
an epoxy board placed between the first structure and the second structure.

12. The transformer of claim 11, further comprising a third structure identical to the first structure, the second structure being stacked between the first structure and the third structure such that the first, second and third legs of the second structure face away from the first, second and third legs of the third structure.

13. A transformer winding comprising:
a first metal sheet of a first sheet type, the first sheet type comprising a first body in a ring shape with a first opening on a lower portion of the ring shape, and a first terminal and a second terminal extending respectively downward from two ends of the first opening;
a second metal sheet of a second sheet type, the second sheet type comprising a second body in the ring shape with a second opening on the lower portion of the ring shape, and a first terminal and a second terminal extending respectively downward from two ends of the second opening, the second opening being different from the first opening,
a distance between the first terminal and the second terminal of the second sheet type being same as a distance between the first terminal and the second terminal of the first sheet type,
first terminals and second terminals of the first metal sheet and the second metal sheet having a same width, and
the first metal sheet and the second metal sheet being stacked with one on top of the other along a centerline of the ring shape; and
an insulating film disposed between the first metal sheet and the second metal sheet.

14. The transformer winding of claim 13, wherein the second terminal of the first metal sheet overlaps the first terminal of the second metal sheet.

15. The transformer winding of claim 14, wherein the second terminal of the first metal sheet and the first terminal of the second metal sheet are aligned with the centerline.

16. The transformer winding of claim 13, wherein the first terminal and the second terminal of the first metal sheet are at a same side of the centerline.

17. The transformer winding of claim 13, wherein the first metal sheet and the second metal sheet are copper sheets.

18. An apparatus comprising a transformer, the transformer comprising:
a core comprising a first leg, a second leg, and a third leg disposed between the first leg and the second leg;
a first secondary winding disposed around the first leg, the first secondary winding comprising a first copper sheet of a first sheet type and a second copper sheet of a second sheet type, the first copper sheet and the second copper sheet being stacked with a rear surface of the first copper sheet disposed on top of a front surface of the second copper sheet, the first sheet type comprising a first body in a ring shape with a first opening, and a first terminal and a second terminal extending respectively from two ends of the first opening along a centerline of the ring shape, and the second sheet type comprising a second body in the ring shape with a second opening, and a first terminal and a second terminal extending respectively from two ends of the second opening along the centerline;
a second secondary winding disposed around the second leg, the second secondary winding comprising a third copper sheet of the first sheet type and a fourth copper sheet of the second sheet type, the third copper sheet and the fourth copper sheet being stacked with a front surface of the third copper sheet disposed on top of a rear surface of the fourth copper sheet; and
a third secondary winding disposed around the third leg, the third secondary winding comprising a fifth copper sheet and a sixth copper sheet of a third sheet type, the fifth copper sheet and the sixth copper sheet being stacked with a rear surface of the fifth copper sheet disposed on top of a rear surface of the sixth copper sheet, the third sheet type comprising a third body in the ring shape with a third opening, and a first terminal and a second terminal extending respectively from two ends of the third opening along the centerline; and
wherein:
respective distances between first terminals and second terminals of the first, second and third sheet types are same; and
respective distances from the first terminals or the second terminals of the first, second and third sheet types to the centerline of the ring shape are different from one another, centerlines of the first to sixth copper sheets being perpendicular to the longitudinal direction of the core.

19. The apparatus of claim 18, wherein:
the second terminal of the first copper sheet is electrically coupled to the first terminal of the second copper sheet;
the second terminal of the third copper sheet is electrically coupled to the first terminal of the fourth copper sheet; and
the second terminal of the fifth copper sheet is electrically coupled to the second terminal of the sixth copper sheet.

20. The apparatus of claim 18, the transformer further comprising:
an electronic component or device disposed on the first terminal or the second terminal of the first, second, third, fourth, fifth or sixth copper sheet, the electronic component or device comprising a first pad electrically coupled to the first terminal or the second terminal and a second pad serving as a terminal of a corresponding winding.
